(19) United States
(12) Patent Application Publication
(10) Pub. No.: US 2025/0029195 A1
(43) Pub. Date: Jan. 23, 2025

(54) SYSTEM AND METHOD FOR MARRIAGE REGISTRATION

(71) Applicant: Aiden Leathers, New York, NY (US)

(72) Inventor: Aiden Leathers, New York, NY (US)

(21) Appl. No.: 18/779,751

(22) Filed: Jul. 22, 2024

Related U.S. Application Data
(60) Provisional application No. 63/528,281, filed on Jul. 21, 2023.

(51) Int. Cl. G06Q 50/26

(52) U.S. Cl. CPC G06Q 50/265

(57) ABSTRACT

A system and method for marriage registration are provided. The system includes at least one client device configured to receive data items from a plurality of users seeking to register a marriage, including a first spouse, a second spouse, and at least one witness. The client device transmits the data items to a government for authentication, via network interfaces. The government authentications the transmitted data items, and in response to authentication provides at least one registration certificate for the marriage.

### CROSS-REFERENCE TO RELATED APPLICATION

This application claims the benefit of priority of U.S. provisional application No. 63/528,281, filed Jul. 21, 2023, the contents of which are herein incorporated by reference.

### BACKGROUND OF THE INVENTION

The present invention relates to registration systems and methods. and, more particularly, to a marriage registration system and method configured to prevent discrimination, fraud, theft, and harassment in inheritance scenarios.

Discrimination, fraud, theft and harassment against widows continues to be pervasive and chronic problems in emerging market countries. In certain nations, mostly in Asia and Africa, widowed women find themselves with no effective means to prove their prior marital status upon the passing of their husbands. While national laws should provide for their immediate and categorical inheritance of their deceased husband's property, they find themselves in a catastrophic quandary. Often at the mercy of in-laws to vouch for their marital status to government officials, those in-laws are the very persons with strong financial interests to deny the legitimacy or existence of the marriage, repudiate knowledge of the victimized woman, and siphon property through illegal, dishonest, fraudulent means. Human Rights Watch, for example, has for many years studied and reported on women's descent into indigency based on these unjust circumstances.

Most marriages in the emerging markets are customary or religious in nature and are not registered with their respective governments. In these countries, less than 20% of marriages are registered with their respective governments. The small percentage of marriages that are registered are done through a few dedicated government offices in country, often requiring long and unaffordable travel. This registration process is generally paper intensive and not automated.

Simultaneously, it would be relatively inexpensive for a nation to invest minuscule resources to keep a database and server running, for perpetuation of government records. With the growing penetration of smart phones and internet access, even in poor communities, opportunities are just now arising to address the aforementioned social ills.

What is needed is a tool that will facilitate government marriage registrations, enabling nations or other trusted authorities to track defined populations. This will not only enhance human rights for women but will also facilitate proper development and planning of housing, education, healthcare, social protection, infrastructure, and other critical resource allocations.

### SUMMARY OF THE INVENTION

In one aspect of the present invention, a computer implemented method of registering a marriage is provided. The method receives, via a first user interface of a first device, at least one data item of a first user and a second user. In embodiments, the first user is a first spouse, the second user is a second spouse, and the at least one data item includes a demographic information, such as a name, a place of birth, a date of birth, a phone number, an address, or at least one unique governmental identifier, and a signature. Additionally, the at least one unique governmental identifier is at least one of a government issue identification document or a birth certificate. A third user information, such as witness information, can be received by the first user device and can include at least one data item, such as a name, a place of birth, a date of birth, a phone number, an address, or at least one unique governmental identifier, and a signature. Once all data items are received by the first device they can be packaged and transmitted to a government for authentication and/or verification. Once authenticated a verification certificate can be transmitted to the first device indicating successful registration of a marriage.

In another aspect of the present invention, a marriage registration system is provided which includes at least one processor and at least one memory storing instructions that when executed cause the system to perform a method. The method causes the system to receive via a at least one data item of a first user from a first user interface, and to receive at least one identification item of the first user from a peripheral device. At least one data item of a second user can be received via a second user interface and at least one identification item of the second user can be received via the peripheral device. At least one data item of a third user can be received via a third user interface and at least one identification item of the third user can be received via the peripheral device. Once all information is received from the plurality of user interfaces the information is packaged for transmittal to a trusted authority. Once transmitted, and in response to a verification by the trusted authority, at least one verification token can be provided to the system from the trusted authority.

These and other features, aspects and advantages of the present invention will become better understood with reference to the following drawings, description, and claims.

### BRIEF DESCRIPTION OF THE DRAWINGS

FIG. 1 is flowchart of a method of registering a marriage, according to aspects of the present invention;

FIG. 2 is an embodiment of a Graphical User Interface of a landing page of a marriage registration system, in accordance with aspects of the present invention;

FIG. 3 is an embodiment of a Graphical User Interface of a first user registration of the marriage registration system, in accordance with aspects of the present invention;

FIG. 4 is an embodiment of a Graphical User Interface of a second user registration of the marriage registration system, in accordance with aspects of the present invention;

FIG. 5 is an embodiment of a Graphical User Interface of a witness registration of the marriage registration system, in accordance with aspects of the present invention; and

FIG. 6 is an embodiment of a block diagram of a system for marriage registration, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As stated above, women are presently vulnerable, and governments ill-informed about demographics, for lack of proper infrastructure for registration of marriages-a seemingly trivial government obligation for those living in wealthy countries, but an essential and unmet need in the developing world.

Broadly, one embodiment of the present invention is a system and method for registering marriages. The present invention operates in a client-server model to provide mechanisms for registration and authentication of marriages. The client device of the present invention can be a computing device, such as a mobile computing device running an application configured to collect at least one data required to register a marriage and can include at least one peripheral device, such as a camera, to capture at least one document. The application is configured to collect basic personal information, demographic data, and any authentication data required by a government needed to register a marriage. The application can be customized to meet the specific requirements of differing governments. The server portion of the present invention can be a computing device configured to interface with the client portion and the database to transmit data, and otherwise facilitate registration of a marriage. The system of the present invention can implement a method for registering a marriage. The method can allow a user(s) utilizing the client device to provide information required by a government to register the marriage. An additional user can verify the marriage utilizing the client device by providing additional information required by a government to register the marriage. All information from the client device can be transmitted by the server to the database, and to the governmental entity. The governmental entity can issue at least one verification in response to receiving information from the client device, indicating successful registration of the marriage.

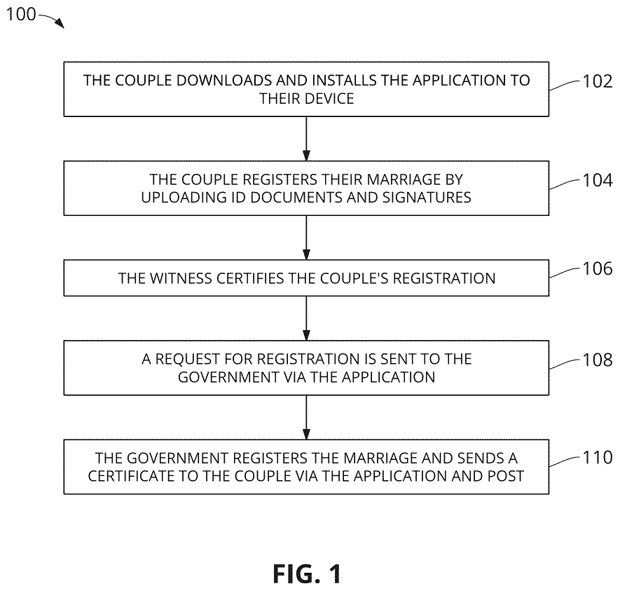

Referring to FIGS. 1-5, aspects of the marriage registration system and method are illustrated. FIG. 1 illustrates method 100 of marriage registration, in accordance with aspects of the present invention. Method 100 begins at step 102 when an application is downloaded to and installed upon a client device of a user(s) wishing to register a marriage. In embodiments, the application can be automatically downloaded from a centralized repository, in response to selection by the user, such as iTunes store, Android Marketplace, Google Play store, etc., and can be automatically installed and configured after downloading. In embodiments, the application can be customizably preconfigured to suit the needs of a trusted authority, such as a government.

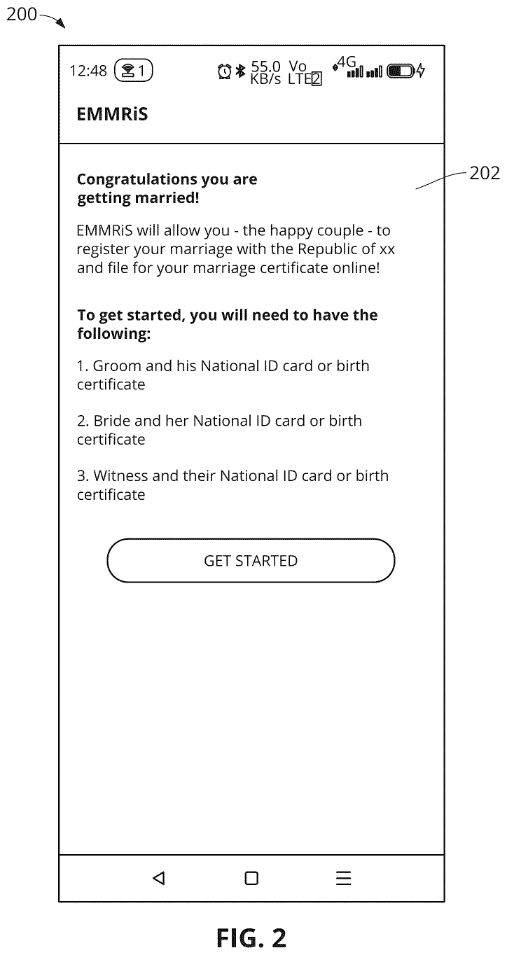

At step 104, a user(s) can begin registering their marriage utilizing the downloaded application. In embodiments, registration begins, as illustrated in FIG. 2, with a welcome screen 200 provided by the application. Welcome screen 200 can provide content 202 related to marriage registration. In embodiments, content 202 can include an introduction, and/or congratulatory message, instructions regarding information required to register a marriage, and at least one interface component to proceed to marriage registration, such as a “Get Started” button. In embodiments, the introduction, and/or instructions can be customized to the specific requirements of the government registering the marriage.

Registration proceeds upon actuation of the at least one interface component, as illustrated in FIG. 2, to a first spousal registration page 300. In embodiments, the first spousal registration page 300 can include a plurality of interface components configured to collect at least one data item 302 required by a government to register the marriage from a first spouse. In embodiments, the at least one data item 302 can include a demographic information, such as a name, a place of birth, a date of birth, a phone number, an address, at least one unique governmental identifier, etc., and a signature. A first user can enter information corresponding to the at least one data item 302 on first spousal registration page 300, and can provide an electronic signature. In embodiments, the first user can utilize a peripheral device of the client device, such as a camera, scanner, or other reproductive imaging device, to capture a government issued identification of the first user, and/or a birth certificate of the first user. In the alternative, the government issued identification and/or the birth certificate can be digitized in any known manner, and can be caused to be stored on the client device for utilization during this step.

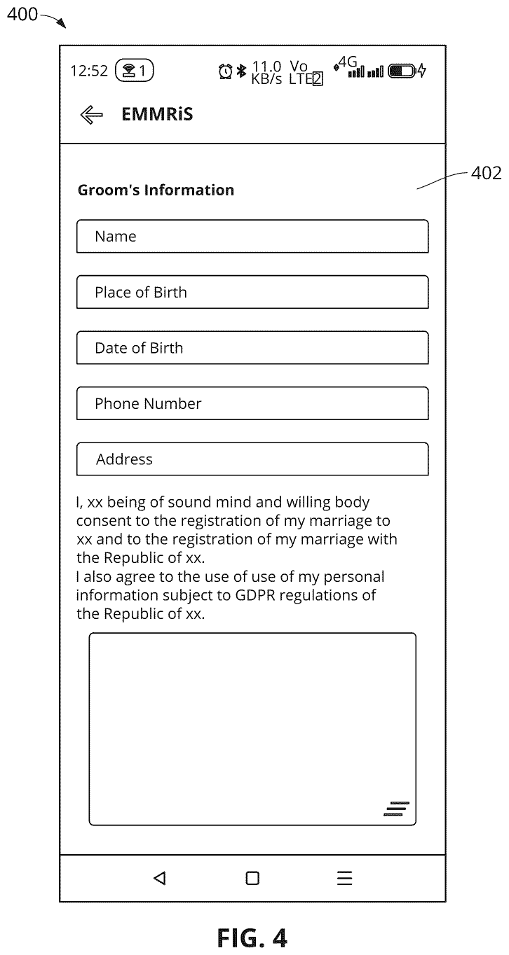

Once first spousal registration page 300 is completed registration a second spousal registration page 400, as illustrated in FIG. 4, is provided by the application. In embodiments, the second spousal registration page 400 can include a plurality of interface components configured to collect at least one data item 402 required by a government to register the marriage. In embodiments, the at least one data item 402 can include a demographic information, such as a name, a place of birth, a date of birth, a phone number, an address, at least one unique governmental identifier, etc., and a signature. A second user can enter information corresponding to the at least one data item 402 on second spousal registration page 400, and can provide an electronic signature. In embodiments, the second user can utilize a peripheral device of the client device, such as a camera, scanner, or other reproductive imaging device, to capture a government issued identification of the second user, and/or a birth certificate of the second user. In the alternative, the government issued identification and/or the birth certificate can be digitized in any known manner, and can be caused to be stored on the client device for utilization during this step.

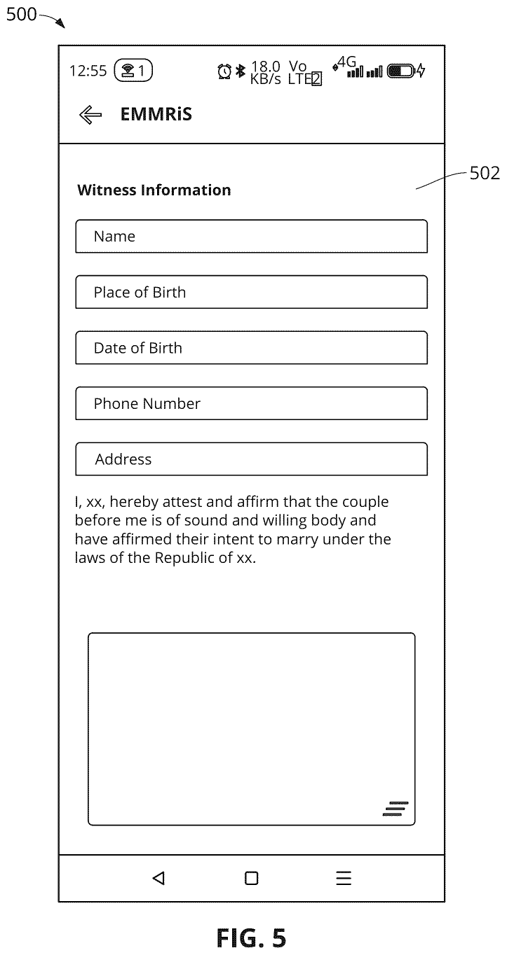

At step 106, an additional user(s) can certify the marriage of the user(s), as illustrated in FIG. 5, by utilizing a witness certification page 500. In embodiments, witness certification page 500 can include a plurality of interface components configured to collect at least one data item 502 required by a government to authenticate the marriage. In embodiments, the at least one data item 502 can include a demographic information, such as a name, a place of birth, a date of birth, a phone number, an address, at least one unique governmental identifier, etc., and a signature. An additional user can enter information corresponding to the at least one data item 502 on witness certification page 500, and can provide an electronic signature. In embodiments, the additional user(s) are witness(es) to the marriage and must be different from the user(s) registering the marriage. In embodiments, the additional user can utilize a peripheral device of the client device, such as a camera, scanner, or other reproductive imaging device, to capture a government issued identification of the additional user, and/or a proof of citizenship of the additional user. In the alternative, the government issued identification and/or the proof of citizenship can be digitized in any known manner, and can be caused to be stored on the client device for utilization during this step.

Once registration and witness certification are completed, at step 108, a request for registration is sent to the government registering the marriage. In embodiments, all information collected via the application is transmitted from the application to the government systems utilizing network connections. In embodiments, once all information is entered into the application one of the first user, the second user, or the additional enter can cause information to be transmitted to the government systems by actuating a user interface components, such as pressing a “Submit” button, and/or any known interface component for advancing execution. Additionally, all information collected can be packaged, compressed, and/or encrypted, prior to transmission for additional privacy and/or security.

At step 110, the government can register the marriage and send at least one verification to the user(s). In embodiments, registration can consist of reviewing all information provided for accuracy and completeness, such as verifying and/or authenticating an identity of each user, utilizing information provided. Once verification and/or authentication is completed, the government can issue the at least one verification to the user(s). In embodiments, the at least one verification can include a digital certificate issued by the government through the application, and/or a physical certificate delivered via post. In embodiments, the at least one verification can be encrypted, and/or compressed prior to transmission for additional privacy and/or security.

Referring now to aspects of a system for performing method 100. The system can consist of a client-server model. In embodiments, the client device 620 can include one or more electronic devices such as a laptop computer, a desktop computer, a tablet computer, a smartphone, a thin client, a smart appliance, and the like. The client device 620 can include a processing device 604, a communication device 606, a memory device 608, at least one peripheral device, such as a camera, scanner, and/or other reprographic device, and a I/O interface 610 which can be interconnected via a system bus. The system bus can be and/or include a control bus, a data bus, and address bus, and so forth.

Additionally, Trusted authority system 602 can include one or more electronic devices such as a laptop computer, a desktop computer, a tablet computer, a smartphone, a thin client, a smart appliance, and the like. The client device 620 can include a processing device 604, a communication device 606, a memory device 608, at least one peripheral device, such as a camera, scanner, and/or other reprographic device, and a I/O interface 610 which can be interconnected via a system bus. The system bus can be and/or include a control bus, a data bus, and address bus, and so forth.

The processing device 604 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device 604. While the system refers to a single processing device 604, the system can include multiple processing devices 604, whether the same type or different types.

The memory device 608 can be and/or include computerized storage medium capable of storing electronic data temporarily, semi-permanently, or permanently. The memory device 608 can be or include a computer processing unit register, a cache memory, a magnetic disk, an optical disk, a solid-state drive, and so forth. The memory device 608 can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 608. While the system refers to a single memory device 608, the system can include multiple memory device 608s, whether the same type or different types.

The communication device 606 enables the Trusted authority system 602 to communicate with other devices and systems, such as client device 620. The communication device 606 can include, for example, a networking chip, one or more antennas, and/or one or more communication ports. The communication device 606 can generate radio frequency (RF) signals and transmit the RF signals via one or more of the antennas. The communication device 606 can generate electronic signals and transmit the RF signals via one or more of the communication ports. The communication device 606 can receive the RF signals from one or more of the communication ports. The electronic signals can be transmitted to and/or from a communication hardline by the communication ports. The communication device 606 can generate optical signals and transmit the optical signals to one or more of the communication ports. The communication device 606 can receive the optical signals and/or can generate one or more digital signals based on the optical signals. The optical signals can be transmitted to and/or received from a communication hardline by the communication port, and/or the optical signals can be transmitted and/or received across open space by the communication device 606.

The communication device 606 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The Trusted Authority system 602 can communicate with one or more network resources via a network. The one or more network resources can include external databases, social media platforms, search engines, file servers, web servers, or any type of computerized resource that can communicate with the system via the network.

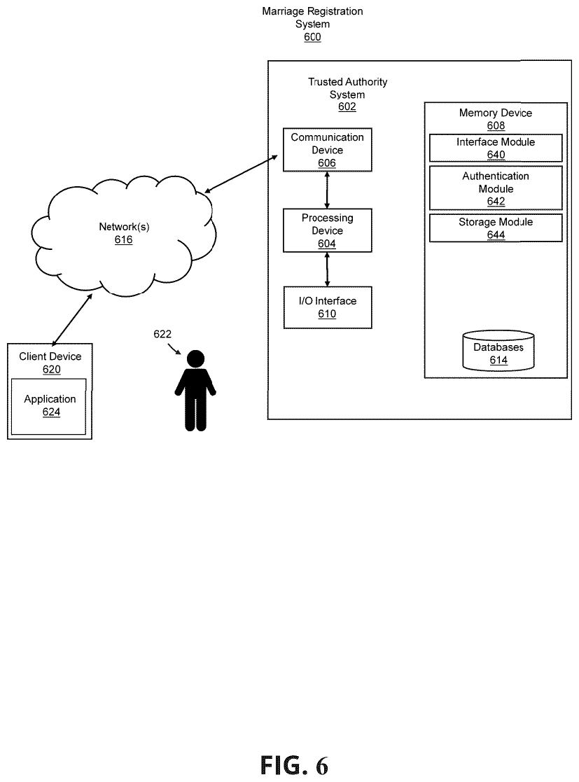

The Trusted Authority system 602 can communicate with client device 620 via the network 616. A user, or plurality of users, 622 can utilize client device 620 to communicate with the Trusted Authority system 602. While FIG. 6 illustrates one client device 620, multiple client devices can be operated by the user 622 or operated by other users.

According to the aspects of the present disclosure, the Trusted Authority system 602 enables the user 622, operating a copy of an application 624 executing on the user device 620, to communicate with the Trusted Authority system 602 and leverage the service provided by the Trusted Authority system 602. The Trusted Authority system 602 is configured to authenticate a marriage registration request as outlined in method 100, steps 108-110, and to issue at least one verification as outlined in method 100, step 110.

To perform the process described herein, the Trusted Authority system 602 can store and execute an Interface module 640, an Authentication module 642, and an Storage module 644 to perform the processes and methods described herein. The Interface module 640, the Authentication module 642, and the Storage module 644 can be stored in the memory device 608. The Interface module 640, the Authentication module 642, and the Storage module 644 can include the necessary logic, instructions, and/or programming to perform the processes and methods described in further detail below. The Interface module 640, the Authentication module 642, and the Storage module 644 can be written in any programming language.

In embodiments, the application 624 can be a specifically designed application that operates with the Trusted Authority system 602 to perform the processes and methods described herein. The memory device 608 can also include one or more databases 614 that store information and data associated with the process and methods described below in further detail.

According to aspects of the present disclosure, the Trusted Authority system 602, for example, via the Interface module 640, provides unique interfaces that allow the user 622 to have their marriage registered and authenticated. The Trusted Authority system 602, for example, via the Interface module 640, provides interfaces to allow a trusted authority to authenticate a marriage based on information received from application 624 from client device 620. Additionally, Interface module 620, provides interfaces to allow a trusted authority to create, updated, edit, or otherwise cause to issue, at least one verification in response to authentication of information received from application 624. The Interface module 640 operates to generate and provide graphical user interfaces (GUIs) to the application 622, for example, menus, widgets, text, images, fields, etc., as described below in further detail. The GUIs generated by the Interface module 640 can be interactive. The Trusted Authority system 602, for example, via the Interface module 640, also provide one or more application programming interface (APIs) that provide connection points for one or more application, e.g., the application 624.

According to aspects of the present disclosure, the Trusted Authority system 602, for example, via the Authentication module 642, provides functionality to allow a trusted authority to authenticate a marriage based on information received from application 624 from client device 620. Additionally, Authentication module 622, provides functionality to allow a trusted authority to create, updated, edit, or otherwise cause to issue, at least one verification in response to authentication of information received from application 624.

According to aspects of the present disclosure, the Trusted Authority system 602, for example, via the Storage module 644, provides functionality to allow a trusted authority to store information received from application 624 via client device 620. In embodiments, Storage module 644 can provide functionality to store all information enter into application by the first user, the second user, and the additional user, when transmitted by application 624 via client device 620, into database 614. Additionally, Storage module 644 can provide functionality to store the at least one verification into database 614 thereby providing a digital repository of registered marriages.

An illustrative, non-limiting example, of system 600 executing method 100 is provided. User 622 can download the marriage registration application 624 on client device 622. Installation of marriage registration application 624 on client device 622 can proceed using methods known in the art. Once installation is completed, welcome screen 200 can be provided on client device 622 through application 624. User 622 can actuate a user interface component to begin marriage registration, such as “Get Started”, illustrated in FIG. 2.

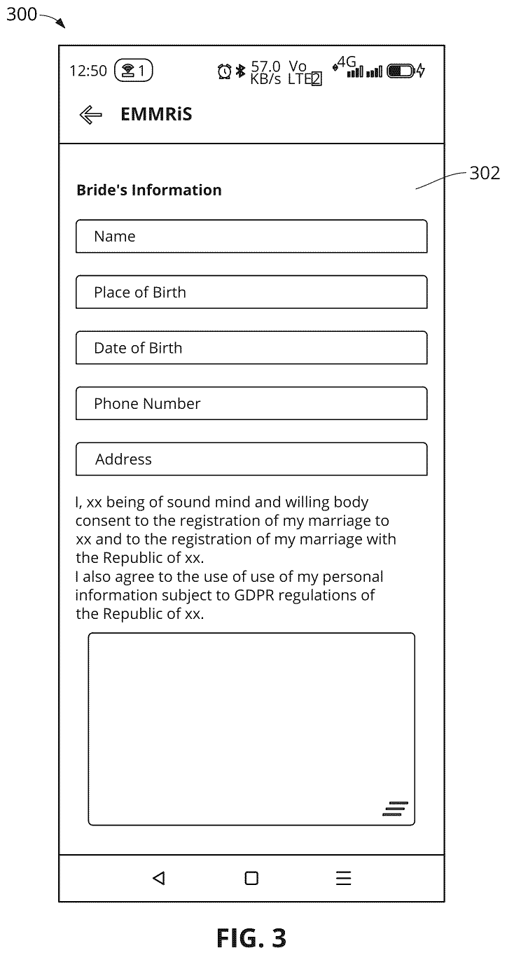

Registrations begins and user 622 is provided with a first spousal registration page 300, as illustrated in FIG. 3, on client device 620. In embodiments, the first spousal registration page 300 can include a plurality of interface components configured to collect at least one data item 302 required by a government to register the marriage from a first spouse. In embodiments, the at least one data item 302 can include a demographic information, such as a name, a place of birth, a date of birth, a phone number, an address, at least one unique governmental identifier, etc., and a signature. A first user of user 622 can enter information corresponding to the at least one data item 302 on first spousal registration page 300, and can provide an electronic signature. In embodiments, the first user can utilize a peripheral device of the client device 620, such as a camera, scanner, or other reproductive imaging device, to capture a government issued identification of the first user, and/or a birth certificate of the first user. In the alternative, the government issued identification and/or the birth certificate can be digitized in any known manner, and can be caused to be stored on the client device 620 for utilization during this step.

Registration continues and user 622 is provided with second spousal registration page 400, as illustrated in FIG. 4, on client device 620. In embodiments, the second spousal registration page 400 can include a plurality of interface components configured to collect at least one data item 402 required by a government to register the marriage from a first spouse. In embodiments, the at least one data item 402 can include a demographic information, such as a name, a place of birth, a date of birth, a phone number, an address, at least one unique governmental identifier, etc., and a signature. A second user of user 622 can enter information corresponding to the at least one data item 402 on first spousal registration page 400, and can provide an electronic signature. In embodiments, the second user can utilize a peripheral device of the client device 620, such as a camera, scanner, or other reproductive imaging device, to capture a government issued identification of the second user, and/or a birth certificate of the second user. In the alternative, the government issued identification and/or the birth certificate can be digitized in any known manner, and can be caused to be stored on the client device 620 for utilization during this step.

Registration continues and user 622 is provided with witness certification page 500, as illustrated in FIG. 5 on client device 620. In embodiments, witness certification page 500 can include a plurality of interface components configured to collect at least one data item 502 required by a government to authenticate the marriage. In embodiments, the at least one data item 502 can include a demographic information, such as a name, a place of birth, a date of birth, a phone number, an address, at least one unique governmental identifier, etc., and a signature. An additional user of user 622 can enter information corresponding to the at least one data item 502 on witness certification page 500, and can provide an electronic signature. In embodiments, the additional user(s) are witness(es) to the marriage and must be different from the user(s) registering the marriage. In embodiments, the additional user can utilize a peripheral device of the client device 620, such as a camera, scanner, or other reproductive imaging device, to capture a government issued identification of the additional user, and/or a proof of citizenship of the additional user. In the alternative, the government issued identification and/or the proof of citizenship can be digitized in any known manner, and can be caused to be stored on the client device 620 for utilization during this step.

Once all information is entered into the first spousal registration page 300, the second spousal registration page 400, and witness certification page 500, the information can be submitted by application 124 through network 616 to Marriage Registration system 600. In embodiments, all information can be packaged, compressed, encrypted, and/or otherwise modified by known methods to protect privacy and for efficient transmission of data. The information provided by application 124 can be view and authenticated by a trusted authority utilizing the interface module 640 and authentication module 642 of Trusted Authority system 602. In embodiments, interface module 640 provide user interface components to view, update, modify, and/or otherwise interact with information provided by application 124, while Authentication module 642 provides functionality to allow a trusted authority to authentication information provided by application 124. For example, interface module 640 and authentication module 642 can allow a trusted authority to view all demographic information provided by the first user, the second user, and the additional user, and can provide additional functionality to allow the trusted authority to verify the validity of documents provided such as government identifications, birth certificates, and/or proofs of citizenship. Finally, in response to verification, Authentication module 642 can cause at least one of a digital certificate, and/or a physical certificate to be issued for a marriage.

Once authenticated all information provided by application 124 can be stored, via storage module 644, to database 614 to provide a digital record of a marriage registration. Additionally, the digital certificate can be stored in associated with information provided by application 124. In embodiments, Storage module 644 causes a unique record to be created an stored in database 614 which can include all information provided by the first user, all information provided by the second user, all information provided by the additional user, and the digital certificate created in correspondence with the information provided by the above users.

Finally, the at least one digital certificate and/or physical certificate can be provided to user 622. In embodiments, the at least one digital certificate is transmitted from Trusted Authority system 602 to client device 620 for display in application 124, via network 616. Additionally, the at least one physical certification can be provided by known shipping methods, such as post. In embodiments, the at least one physical certification can be shipped to an address provided as part of demographic information provided by the first user, or the second user.

As described above, the system can include hardware components to perform the processes described herein. In embodiments, one or more of components, hardware, and/or functionality of the system can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the system can be and/or include a server device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the system, including the server and/or the client device can provide I/O devices for outputting information in a format perceptible by a user and receiving input from the user. For example, the system can communicate with the I/O devices via the I/O interface 610. The I/O devices can display graphical user interfaces (“GUIs”) generated by the system. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

It should be understood, of course, that the foregoing relates to exemplary embodiments of the invention and that modifications may be made without departing from the spirit and scope of the invention as set forth in the following claims.

What is claimed is:

1. A computer implemented method of registering a marriage, comprising:
receiving, via a first user interface of a first device, at least one data item of a first user;
receiving, via a second user interface the first device, at least one data item of a second user;
receiving, via a third user interface the first device, at least one data item of a third user;
packaging the at least one data item of the first user, the at least one data item of the second user, and the at least one data item of the third user to form a registration request;
transmitting the registration request to a second device;
authenticating, at the second device, the registration request to form a verification certificate;
transmitting the verification certificate to the first device.

2. The method of claim 1, wherein the at least one data item of the first user, and the at least one data item of the second user includes at least one of: a demographic information, and a signature.

3. The method of claim 2, wherein the demographic information includes at least one of: a name, a place of birth, a date of birth, a phone number, an address, or at least one unique governmental identifier.

4. The method of claim 3, wherein the at least one unique governmental identifier includes at least one of: a government issued identification document, or a birth certificate.

5. A marriage registration system, comprising:
at least one processor and at least one memory storing instructions that when executed cause the system to perform a method, the method comprising:
receiving, via a first user interface, at least one data item of a first user;
receiving, via a peripheral device, at least one identification item of the first user;
receiving, via a second user interface, at least one data item of a second user;
receiving, via the peripheral device, at least one identification item of the second user;
receiving, via a third user interface, at least one data item of a third user;
receiving, via the peripheral device, at least one identification item of the third user;
packaging, the at least one data item of the first user, the at least one identification item of the first user, the at least one data item of the second user, the at least one identification item of the second user, the at least one data item of the third user, the at least one identification item of the third user, to form a marriage registration package;
transmitting, to a first device, the marriage registration package for authentication by a trusted authority;
in response to verification of the marriage registration package by the trusted authority, receiving at least one verification token from the first user device.
